(19) United States
(12) Patent Application Publication
(10) Pub. No.: US 2017/0045951 A1
(43) Pub. Date: Feb. 16, 2017

(54) INTERACTIVE MENU

(71) Applicant: Robert Bosch GmbH, Stuttgart (DE)

(72) Inventors: Christoph Delfs, Bretten (DE); Niklas Dittrich, Pliezhausen (DE); Lutz Rauscher, Reutlingen (DE); Frank Fischer, Gomaringen (DE)

(21) Appl. No.: 15/305,951

(22) PCT Filed: Mar. 2, 2015
(86) PCT No.: PCT/EP2015/054275

§ 371 Date: Oct. 21, 2016

(30) Foreign Application Priority Data
Apr. 28, 2014 (DE) 10 2014 207 963.2

(51) Int. Cl. G06F 3/01; G06F 3/042

(52) U.S. Cl. CPC G06F 3/017; G06F 3/0426; G06F 3/0423; G06F 2203/04108

(57) ABSTRACT

A method is provided for non-contact interaction with a module, the module including a first submodule and a second submodule, a primary beam being generated by the first submodule in a first method step, the primary beam being deflected by the second submodule in a second method step in such a way that a piece of image information is projected onto a projection area, the primary beam being deflected by the second submodule in a third method step in such a way that a piece of operating information is projected onto an operating area, a control signal being generated by the module in a fourth method step if a control command is detected in a locating zone associated with the primary beam, the operating area being projected onto an operating object in the third method step if the operating object is positioned in the locating zone.

### FIELD

The present invention is directed to a method for non-contact interaction with a module. Furthermore, the present invention is directed to a laser projector and a module including an interface for non-contact interaction with an object.

### BACKGROUND INFORMATION

Devices for providing a human-machine interface are generally available.

### SUMMARY

One object of the present invention is to provide a method, a module, and a laser projector, whereby non-contact interaction by a user with a comparatively compact and economically designed module and/or laser projector is made possible.

The method according to the present invention for non-contact interaction with the module, the module, and the laser projector may have the advantage over the related art that, by projecting the operating area onto the operating object, non-contact control of a module and/or the laser projector is made possible. For example, virtually any arbitrary operating object may be used, onto which the operating area is projected. For example, the operating object is a hand of a user. Furthermore, it is advantageously possible that the space requirement of the module, for example, in comparison to a relatively complicated detection of the operating object by a camera, is small, since the same primary beam may be used for the detection of the object or the operating object as is also used for the projection of the image information. For example, the operating area includes multiple operating elements, one control command being associated with each operating element of the multiple operating elements. As a result of the operating object being detected (only) if the operating object is positioned into the locating zone or the beam path associated with the projection of the image information, a comparatively simple and convenient call of a menu is additionally made possible for controlling the laser projector and/or the module.

Advantageous embodiments and refinements of the present invention are described herein, with reference to the figures.

According to one preferred refinement, it is provided that the operating object is scanned by the primary beam if the operating object is positioned in the locating zone, a geometric shape of the operating object being detected by the module as a function of a detection of a secondary signal generated via interaction of the primary beam with the operating object.

As a result, it is advantageously possible that the geometric shape of the operating object is detected using the primary beam, so that additional separate elements for the detection of the geometric shape may be dispensed with. In this case, the geometric shape of the operating object relates in particular to a contour of the operating object along a path around the operating object running essentially perpendicular to a radiation direction of the primary beam.

According to another preferred refinement, it is provided that the operating area is projected onto the operating object in such a way that the operating area is adapted to the geometric shape of the operating object.

As a result, it is advantageously possible to use a plurality of different operating objects. For example, as a result, an operating area adjusted to the size of a palm of the hand is projected onto the palm of the hand, so that a comparatively reliable interaction with the module and/or laser projector is achieved independently of the age of the user.

According to another preferred refinement, it is provided that the control command is detected if an object is detected in a solid angle range of the locating zone associated with the operating area.

As a result, it is advantageously possible that a selection of an operating element in the operating area is detectable via the object, for example, the finger of the user.

According to another preferred refinement, it is provided that a piece of confirmation information is projected onto the object and/or the operating object in the operating area if the object is detected in the solid angle range of the locating zone associated with the operating area. According to another preferred refinement, it is provided that the control command is detected by the module if the object is detected in the solid angle range of the locating zone associated with the operating area for the duration of a predetermined time interval.

As a result, it is advantageously possible that the selection of the control command is confirmed to the user, so that the precision with which the control command is detected is still further improved.

According to a preferred refinement, it is provided that the operating object is a hand of the user, the operating area being projected onto a palm of the hand.

As a result, it is advantageously possible to provide particularly user-friendly and simultaneously non-contact interaction with the module and/or laser projector.

According to an additional preferred refinement, it is provided that the first and/or second submodule is/are controlled in such a way that a modified piece of image information is projected onto the projection area as a function of the control signal.

According to another preferred refinement, it is provided that the module is integrated into a laser projector, the laser projector being controlled as a function of the control signal, the laser projector in particular having a sound generation means and/or a display means, the sound generation means and/or the display means of the laser projector in particular being controlled as a function of the control signal.

As a result, it is advantageously possible that media content depicted by the laser projector, for example, video sequences, are controllable in a particularly interactive and non-contact manner by the user.

According to a preferred refinement of the module according to the present invention, it is provided that the module is configured for scanning the operating object via the primary beam, the module being configured for detecting a geometric shape of the operating object as a function of a detection of a secondary signal generated via interaction of the primary beam with the operating object.

As a result, it is advantageously possible that the geometric shape of the operating object is detected using the primary beam, so that additional separate elements for detecting the geometric shape may be dispensed with.

According to another preferred refinement of the module according to the present invention, it is provided that the second submodule includes a microelectromechanical scanning mirror structure for deflecting the primary beam.

As a result, it is advantageously possible that a module is provided which is compact to such an extent that the module may be integrated into a portable electrical device, for example, a laser projector.

According to another preferred refinement of the laser projector according to the present invention, it is provided that the laser projector is controllable as a function of the control signal of the module, the laser projector having a sound generation means and/or a display means, the sound generation means and/or the display means of the laser projector being controllable as a function of the control signal.

As a result, it is advantageously possible to provide a laser projector including an interactive user interface for non-contact interaction with the user.

Exemplary embodiments of the present invention are depicted in the figures and explained in greater detail below.

### BRIEF DESCRIPTION OF THE DRAWINGS

FIG. 1 shows a module according to one specific embodiment of the present invention.

FIG. 2 shows a laser projector according to one specific embodiment of the present invention.

FIGS. 3 and 4 show an operating area projected onto an operating object according to various specific embodiments of the present invention.

### DETAILED DESCRIPTION OF EXAMPLE EMBODIMENTS

In the various figures, identical parts are always provided with the same reference numerals and are therefore generally also named or mentioned only once in each case.

FIG. 1 depicts a module 2 according to one specific embodiment of the present invention. An interface, in particular a user interface or a human-machine interface (HMI), is provided via module 2 for non-contact interaction with an object 4. Object 4 is in particular a selection object or a control object guided by a user, for example, a finger, a wand, or another solid physical object. In particular, the interaction of module 2 with object 4 takes place via detection of a movement and/or position of object 4, object 4 in particular being located.

Module 2 includes a first submodule 21 for generating a primary beam 3. First submodule 21 is in particular a light module 21, preferably a laser module 21, particularly preferably a red-green-blue (RGB) module 21. Preferably, primary beam 3 is a primary laser beam 3, primary laser beam 3 including red light, green light, blue light, and/or infrared light.

Furthermore, module 2 includes a second submodule 22 for deflecting primary beam 3, so that primary beam 3 in particular carries out a line-type scanning movement. Second submodule 22 is configured in such a way that by deflecting primary beam 3, a piece of image information is projected onto a projection area 200 in particular onto a projection surface 200 of a projection object 20. This means in particular that the scanning movement of primary beam 3 takes place in such a way that an image which is visible to the user is projected onto projection object 20, for example, a wall, via primary beam 3. In particular, the piece of image information relates to an image which is assembled line-by-line, for example, a single image or still image of a video sequence, a photographic image, a computer generated image, and/or other image. Preferably, second submodule 22 is a scanning module 22 or scanning mirror module 22, scanning mirror module 22 particularly preferably including a microelectromechanical system (MEMS) for deflecting primary beam 3. Preferably, primary beam 3 is subjected to a deflection movement by second submodule 22 in such a way that primary beam 3 carries out the scanning movement (i.e., in particular a multiple-line or raster-like scanning movement) along projection area 200 (i.e., in particular along projection surface 200 of projection object 20). Preferably, scanning mirror module 22 is configured for generating a (time-dependent) deflection position signal with respect to a deflection position of scanning mirror module 22 during the scanning movement.

Preferably, module 2 includes a third submodule 23, in particular a detection module 23, for detecting a secondary signal 5 generated via interaction of primary beam 3 with object 4. For example, the secondary signal is generated via reflection of primary beam 3 off object 4, if object 4 is positioned and/or moved relative to module 2 in such a way that object 4 is detected by primary beam 3 during the scanning movement of primary beam 3. This means, for example, that object 4 is positioned in a locating zone 30 associated with primary beam 3.

In particular, a (time-dependent) detection signal is generated via detection module 23, the detection signal in particular including a piece of information with respect to detected secondary signal 5.

Preferably, module 2 includes a fourth submodule 24 for generating a locating signal, the locating signal in particular including a piece of information with respect to a (time) correlation of the detection signal with the deflection position signal. As a result, it is advantageously possible that a position and/or a movement and/or a distance of object 4 (relative to module 2 and/or relative to projection object 20) is detected in a non-contact manner, in particular by locating object 4 via primary beam 3. In this case, “locating” in particular means a position determination and/or distance determination (using primary beam 3).

Preferably, module 2 furthermore includes a fifth submodule 25 for controlling first submodule 21 and/or second submodule 22. For example, fifth submodule 25 is a control module 25 for generating a control signal for controlling first submodule 21 and/or second submodule 22, the control signal in particular being generated as a function of the locating signal.

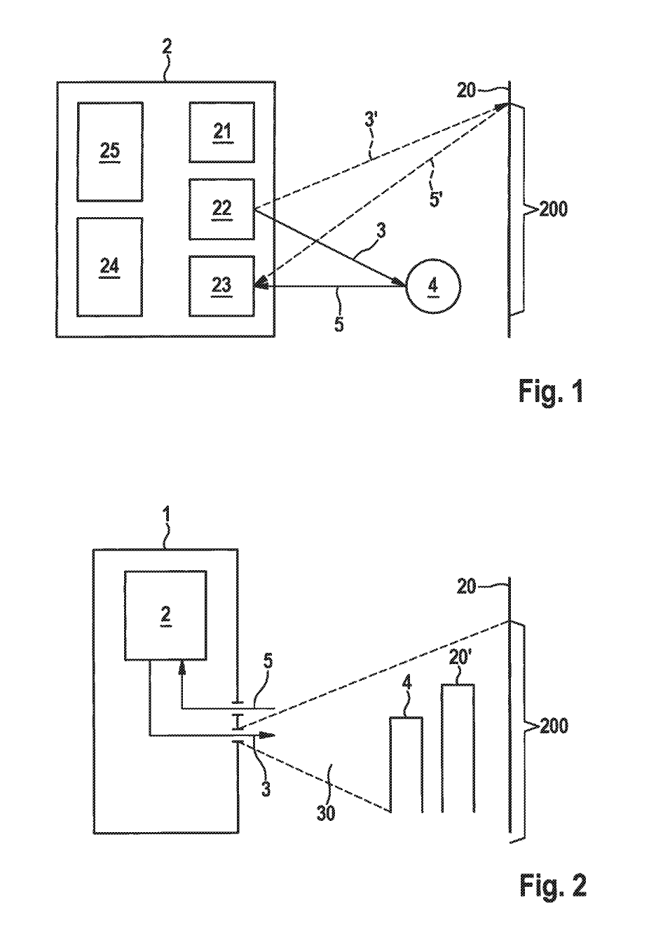

FIG. 2 depicts a laser projector 1 according to one specific embodiment of the present invention, a module 2 according to the present invention being integrated into laser projector 1. The specific embodiment of module 2 depicted here is in particular essentially identical to the other specific embodiments according to the present invention. The method according to the present invention for non-contact interaction with module 2 includes the steps described below. In a first method step, primary beam 3 is generated by first submodule 21, primary beam 3 being deflected in a second method step by second submodule 22 in such a way that a piece of image information is projected onto a projection area 200 onto projection object 20, i.e., here, projection surface 200 is arranged on a surface of projection object 20. In this case, primary beam 3 is in particular deflected by second submodule 22 in such a way that primary beam 3 carries out a scanning movement along a locating zone 30. Locating zone 30 associated with primary beam 3 is in particular also referred to as an optical path, locating zone 30 in particular being associated with a solid angle range spanned by the scanning movement of primary beam 3. If an operating object 20′ is positioned in locating zone 30, operating object 20′ is initially detected by module 2. For example, operating object 20′ is a hand positioned by a user into locating zone 30 or the optical path, or another operating object 20′ having an essentially planar surface. Preferably, operating object 20′ is detected by locating operating object 20′ via primary beam 3. This means in particular that operating object 20′ is scanned by primary beam 3 (during the scanning movement) if operating object 20′ is positioned in locating zone 30, i.e., in a solid angle range of the optical path associated with projection surface 200, so that a secondary signal 5 generated via interaction of primary beam 3 with operating object 20′ is detected by module 2. Subsequently, a geometric shape of operating object 20′ is detected by module 2 as a function of detected secondary signal 5. In a subsequent third method step, primary beam 3 is deflected by second submodule 22 in such a way that a piece of operating information is projected onto an operating area 300, operating area 300 being projected onto operating object 20′. Preferably, the piece of operating information is projected onto operating area 300 in such a way that operating area 300 is essentially adjusted to the detected geometric shape of operating object 20′, for example, to the palm of the hand of the user. In a fourth method step, a control signal is generated by module 2 if a control command is detected in locating zone 30 associated with primary beam 3. In this case, the control command relates in particular to a position and/or movement of object 4 (guided by the user).

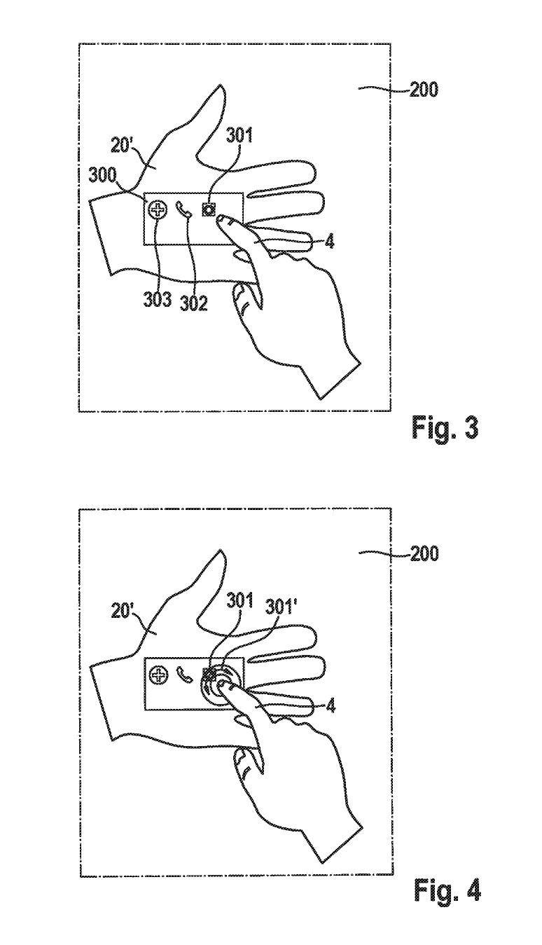

FIG. 3 depicts an operating area 300 projected onto an operating object 20′ according to one specific embodiment of the method according to the present invention, the specific embodiment depicted here generally being identical to the other specific embodiments according to the present invention. If the piece of operating information is initially still blocked out (i.e., the piece of operating information is not projected onto operating area 300 or is not visible), the piece of operating information is displayed (only) if operating object 20′ is positioned into locating zone 30 or into the optical path in such a way that operating object 20′ is detected, in particular located, by module 2 (using primary beam 3). For example, operating object 20′ is detected if operating object 20′ is positioned in a solid angle range associated with projection area 200. Second submodule 22 is preferably configured in such a way that the piece of operating information is projected onto operating area 300 by deflecting primary beam 3. Operating area 300 is used for non-contact interaction of the user with module 2. In particular, the piece of operating information relates to an image which is assembled line-by-line, for example, a single image or still image of a video sequence, a photographic image, a computer generated image, and/or other image. Preferably, the piece of operating information projected onto operating area 300 includes one or multiple operating elements 301, 302, 303 (i.e., graphic symbols) for interaction with the user, a (separate) control command being associated with each operating element 301 of the multiple operating elements.

FIG. 4 depicts an operating area 300 projected onto an operating object 20′ according to one specific embodiment of the method according to the present invention, the specific embodiment depicted here being generally identical to the other specific embodiments according to the present invention. If an object 4 is detected in a solid angle range of locating zone 30 associated with an operating element 301 of operating area 300, the control command associated with operating element 301 is detected. This means, for example, that the user selects an operating element 301 (i.e., a graphic symbol) with finger 4, which is imaged in operating area 300 on the palm of hand 20′ of the user. In this case, a piece of confirmation information 301′, for example, as depicted here in the form of a ring-shaped marking, is projected onto object 4 and/or operating object 20′ in the area of selected operating element 301 in operating area 300, in order to indicate to the user which operating element 301 of multiple operating elements 301, 302, 303 was detected by module 2 by locating object 4. Preferably, in this case, the control command associated with operating element 301 is detected by module 2 (only) if object 4 was detected for the duration of a predetermined time interval, for example, several seconds, in the solid angle range of locating zone 30 associated with operating element 301 of operating area 300.

1-13 (canceled)

14. A method for non-contact interaction with a module, the module including a first submodule and a second submodule, the method comprising:
generating, by the first submodule, a primary beam;
subjecting, by the second submodule, the primary beam a scanning movement so that a piece of image information is projected onto a projection area;
deflecting, by the second submodule, the primary beam so that a piece of operating information is projected onto an operating area; and
generating, by the module, a control signal if a control command is detected in a locating zone associated with the primary beam;
wherein in the deflecting step, the operating area is projected onto an operating object if the operating object is positioned in the locating zone.

15. The method as recited in claim 14, wherein the operating object is scanned by the primary beam if the operating object is positioned in the locating zone, a geometric shape of the operating object being detected by the module as a function of a detection of a secondary signal generated via interaction of the primary beam with the operating object.

16. The method as recited in claim 15, wherein the operating area is projected onto the operating object in such a way that the operating area is adjusted to the geometric shape of the operating object.

17. The method as recited in claim 14, wherein the control command is detected if an object is detected in a solid angle range of the locating zone associated with the operating area.

18. The method as recited in claim 17, wherein a piece of confirmation information is projected onto at least one of the object and the operating object in the operating area, if the object is detected in the solid angle range of the locating zone associated with the operating area.

19. The method as recited in claim 17, wherein the control command is detected by the module if the object is detected in the solid angle range of the locating zone associated with the operating area for a duration of a predetermined time interval.

20. The method as recited in claim 14, wherein the operating object is a hand of a user, the operating area being projected onto a palm of the hand.

21. The method as recited in claim 14, wherein at least one of the first and second submodule is controlled in such a way that a modified piece of image information is projected onto the projection area as a function of the control signal.

22. The method as recited in claim 14, wherein the module is integrated into a laser projector, the laser projector being controlled as a function of the control signal, the laser projector including including at least one of a sound generator and a display, the at least one of the sound generator and display of the laser projector being controlled as a function of the control signal.

23. A module for interfacing for non-contact interaction with an object, the module comprising:
a first submodule for generating a primary beam; and
a second submodule for deflecting the primary beam, the second submodule being configured for generating a scanning movement of the primary beam in such a way that a piece of image information is projected onto a projection area by the module, the second submodule being configured in such a way that a piece of operating information is projected onto an operating area by deflecting the primary beam;
wherein the module is configured to generate a control signal if a control command is detected in a locating zone associated with the primary beam, and to detect an operating object in such a way that the piece of operating information is projected onto the operating object if the operating object is positioned in the locating zone.

24. The module as recited in claim 23, wherein the module is configured for scanning the operating object by the primary beam, the module being configured for detecting a geometric shape of the operating object as a function of a detection of a secondary signal generated via interaction of the primary beam with the operating object.

25. The module as recited in claim 23, wherein the second submodule includes a microelectromechanical scanning mirror structure for deflecting the primary beam.

26. A laser projector, comprising:
a module for interfacing for non-contact interaction with an object, the module including a first submodule for generating a primary beam, and a second submodule for deflecting the primary beam, the second submodule being configured for generating a scanning movement of the primary beam in such a way that a piece of image information is projected onto a projection area by the module, the second submodule being configured in such a way that a piece of operating information is projected onto an operating area by deflecting the primary beam, wherein the module is configured to generate a control signal if a control command is detected in a locating zone associated with the primary beam, and to detect an operating object in such a way that the piece of operating information is projected onto the operating object if the operating object is positioned in the locating zone;
wherein the module is integrated into the laser projector, the laser projector being a mobile telecommunications terminal.
